(19) United States
(12) Patent Application Publication
(10) Pub. No.: US 2023/0083407 A1
(43) Pub. Date: Mar. 16, 2023

(54) SYSTEM AND METHOD FOR FRITTERING ROCK INSIDE A CELLAR USING HIGH ENERGY ELECTROMAGNETIC BEAMS

(71) Applicant: Saudi Arabian Oil Company, Dhahran (SA)

(72) Inventor: Moustafa M. Abouhamed, Dhahran (SA)

(21) Appl. No.: 17/447,504

(22) Filed: Sep. 13, 2021

(51) Int. Cl. E21B 7/15; B23K 26/382

(52) U.S. Cl. CPC E21B 7/15; B23K 26/382

(57) ABSTRACT

A system and method fritter rock inside a cellar around a wellhead using high energy electromagnetic beams. The system includes a high energy electromagnetic emitter, an emitter controller, and a control loop. The high energy electromagnetic emitter is configured to aim a high energy electromagnetic beam into a cellar at the Earth's surface surrounding a wellhead, and to generate the high energy electromagnetic beam to be incident on a rock in the cellar, wherein the high energy electromagnetic beam fritters the rock. The emitter controller is configured by software therein to control an operation and the direction of the high energy electromagnetic beam. The control loop is configured to maintain alignment of the high energy electromagnetic beam with the cellar throughout the frittering to ensure beam/cellar coincidence.

### FIELD OF THE DISCLOSURE

The present disclosure relates generally to destroying rocks in a wellhead environment, and, more particularly, to a system and method for frittering rock inside a cellar around a wellhead using high energy electromagnetic beams.

### BACKGROUND OF THE DISCLOSURE

To install a wellhead above ground, a ground environment is established, such as a portion of the Earth's surface upon which a rig is mounted. The ground environment surrounding the wellhead is referred to as a cellar. The cellar typically extends a relatively short distance below the Earth's surface. In many cases, when digging out the cellar by jack hammers, excavators, and explosives, excessive time is expended to break out hard rock existing inside the cellar. Such hard rock can be intractable, which hinders deeper digging out of the cellar to inspect surface casing conditions.

### SUMMARY OF THE DISCLOSURE

According to an embodiment consistent with the present disclosure, a system and method fritter rock inside a cellar around a wellhead using high energy electromagnetic beams.

In an embodiment, a system comprises a high energy electromagnetic emitter, an emitter controller, and a control loop. The high energy electromagnetic emitter is configured to aim a high energy electromagnetic beam into a cellar at the Earth's surface surrounding a wellhead, and to generate the high energy electromagnetic beam to be incident on a rock in the cellar, wherein the high energy electromagnetic beam fritters the rock. The emitter controller is configured by software therein to control an operation and the direction of the high energy electromagnetic beam. The control loop is configured to maintain alignment of the high energy electromagnetic beam with the cellar throughout the frittering to ensure beam/cellar coincidence.

The high energy electromagnetic emitter is disposed above the Earth's surface. The high energy electromagnetic emitter can be a laser. The high energy electromagnetic beam can be a coherent laser beam. The system further comprises an imaging sub-system configured to obtain an image of the rock in the cellar. The imaging sub-system includes a camera configured to obtain the image, and a camera controller configured by software therein to control the camera. The imaging sub-system can include an output device configured to output the image. The output device can be a monitor configured to display the image.

In another embodiment, a system comprises a high energy electromagnetic emitter, an emitter controller, a control loop, and an imaging sub-system. The high energy electromagnetic emitter is configured to aim a high energy electromagnetic beam into a cellar at the Earth's surface surrounding a wellhead, and to generate the high energy electromagnetic beam to be incident on a rock in the cellar, wherein the high energy electromagnetic beam fritters the rock. The emitter controller is configured by software therein to control an operation and the direction of the high energy electromagnetic beam. The control loop is configured to maintain alignment of the high energy electromagnetic beam with the cellar throughout the frittering to ensure beam/cellar coincidence. The imaging sub-system includes a camera configured to obtain an image of the rock in the cellar, and an output device configured to output the image.

The high energy electromagnetic emitter is disposed above the Earth's surface. The high energy electromagnetic emitter can be a laser. The high energy electromagnetic beam can be a coherent laser beam. The imaging sub-system includes a camera configured to obtain the image, and a camera controller configured by software therein to control the camera. The imaging sub-system includes an output device configured to output the image. The output device can be a monitor configured to display the image.

In a further embodiment, a method comprises aiming a high energy electromagnetic beam emitter at a rock in a cellar at the Earth's surface surrounding a wellhead; generating a high energy electromagnetic beam above the Earth's surface; directing the high energy electromagnetic beam at the rock, thereby frittering the rock; and maintaining alignment of the high energy electromagnetic beam with the cellar throughout the frittering using a control loop to ensure beam/cellar coincidence. The method further comprises obtaining an image of the rock, and displaying the image. The high energy electromagnetic beam can be a coherent laser beam. The high energy electromagnetic beam can be emitted by a high energy electromagnetic emitter disposed above the Earth's surface. The high energy electromagnetic emitter can be a laser.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of a system, according to an embodiment.

FIG. 2 is a flowchart of a method of operation of the system of FIG. 1.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 10 and method 100 configured to fritter rock 28 inside a cellar 26 around a wellhead 24 using high energy electromagnetic beams 32, such as laser beams.

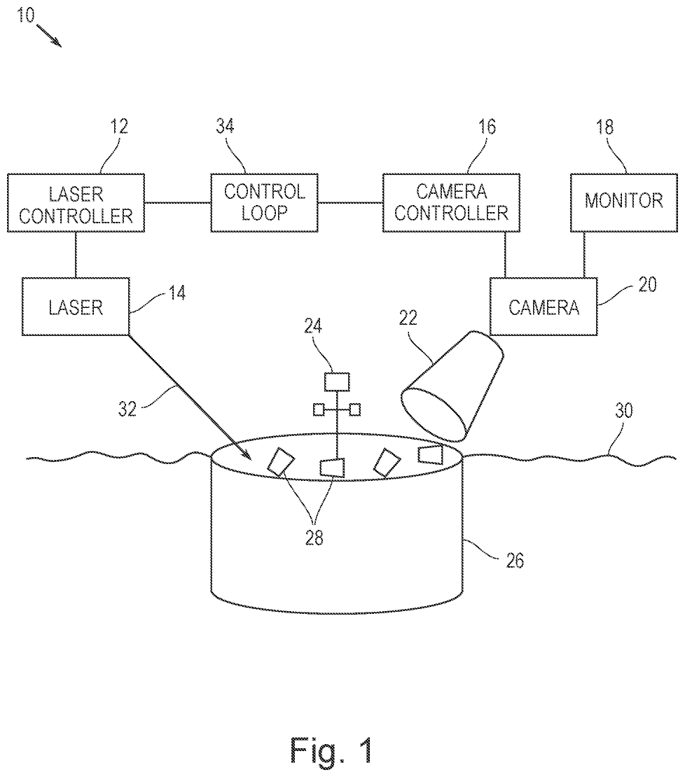

Referring to FIG. 1, the system 10 includes a high energy electromagnetic emitter controller 12, a high energy electromagnetic emitter 14, an imaging sub-system 16, 18, 20, and a control loop 34. The high energy electromagnetic emitter 14 is configured to aim a high energy electromagnetic beam 32 into a cellar 26 at the Earth's surface 30 surrounding a wellhead 24, and to generate the high energy electromagnetic beam 32 to be incident on a rock 28 in the cellar 26, such that the high energy electromagnetic beam 32 fritters the rock 28. The emitter controller 12 is configured by software therein to control an operation and the direction of the high energy electromagnetic beam 32. The control loop 34 is configured to maintain alignment of the high energy electromagnetic beam 32 with the cellar 26 throughout the frittering to ensure beam/cellar coincidence. The imaging sub-system includes a camera controller 16, an output device 18, and a camera 20. The camera 20 is configured to obtain an image of the rock 28 in the cellar 26. For example, the camera 20 has a field-of-view (FoV) 22, with the rock 28 disposed in the FoV 22. The output device 18 is configured to output the image. For example, the output device 18 can be a monitor or display configured to display the image of the rock 28 in the FoV 22.

As shown in FIG. 1, the high energy electromagnetic emitter 14 is disposed above the Earth's surface 30. The high energy electromagnetic emitter 14 can be a laser. For example, the laser can output between 5 kW and 10 kW at wavelengths between 455 nm and 810 nm. The high energy electromagnetic beam 32 can have an M² of less than 2. In at least one implementation the beam can have a beam parameter between 15 mm milliradians and 100 mm milliradians. The high energy electromagnetic emitter controller 12 can be a laser controller. The high energy electromagnetic beam 32 can be a coherent laser beam. Alternatively, the high energy electromagnetic beam 32 can be non-coherent. Other optics can be used with the laser 14 to generate the high energy electromagnetic beam 32. The optics can include a lens, a mirror, or other devices configured to aim the high energy electromagnetic beam 32 at the rock 28 in the cellar 26.

Using the image of the rock 28, the camera controller 16 provides location information regarding the rock 28 to the control loop 24. Such location information can include a relative location of the rock 28 in the cellar 26. The control loop 24 processes such location information to generate control information. The control information is transmitted from the control loop 24 to the laser controller 12. The laser controller 12 uses such control information to control and maintain alignment of the high energy electromagnetic beam 32 with the cellar 26 throughout the frittering to ensure beam/cellar coincidence. Accordingly, the control loop 34 can increase the focusing of the high energy electromagnetic beam 32 into the cellar 26. In particular, the increased focusing permits the high energy electromagnetic beam 32 to maintain incidence onto a targeted rock 28 to fritter the rock 28.

In an alternative embodiment, the system 10 includes a conveying sub-system configured to advance at least the high energy electromagnetic emitter 14 toward the cellar 26 to further fritter additional rocks 28 in the cellar 26. Furthermore, the conveying sub-system can be configured to advance at least the high energy electromagnetic emitter 14 into the cellar 26 to further fritter additional rocks 28 in the cellar 26. In another alternative embodiment, the system 10 includes a cooling system configured to cool the high energy electromagnetic emitter 14. Such cooling prolongs the operational life of the high energy electromagnetic emitter 14.

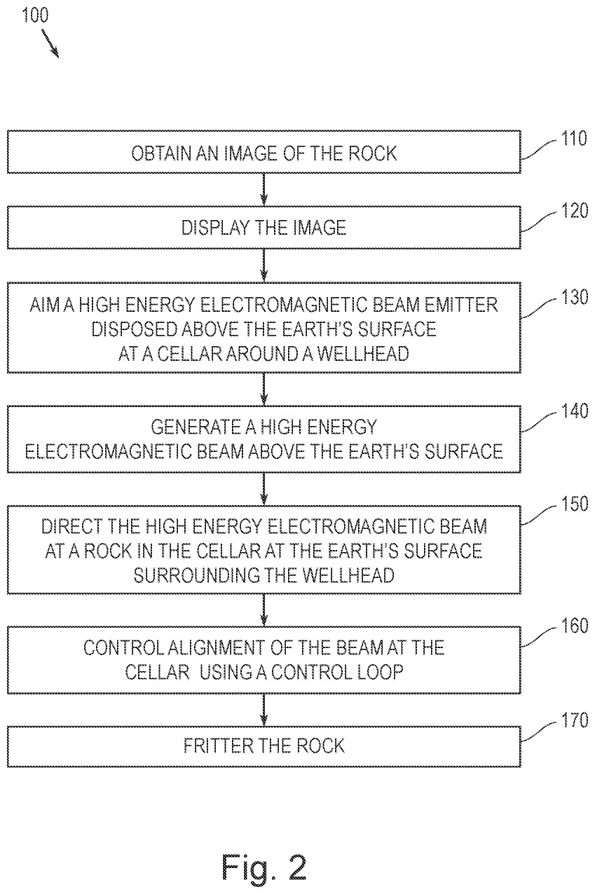

Referring to FIG. 2, the method 100 includes obtaining an image of the rock 28 in step 110, and outputting the image in step 112. The outputting of the image can include displaying the image on the monitor 18. The method 100 further includes aiming the high energy electromagnetic beam emitter 14 at the rock 28 into the cellar 26 at the Earth's surface 30 surrounding the wellhead 24 in step 130. The high energy electromagnetic beam emitter 14 is disposed above the Earth's surface 30. The method 100 then generates the high energy electromagnetic beam 32 above the Earth's surface 30 in step 140, and directs the high energy electromagnetic beam 32 at the rock 28 in step 150. The method 100 also controls alignment of the high energy electromagnetic beam 32 with the cellar 26 using the control loop 34 in step 160 to ensure beam/cellar coincidence. The method 100 then fritters the rock 28 in step 170 using the directed and aligned high energy electromagnetic beam 32.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system, comprising:
a high energy electromagnetic emitter configured to aim a high energy electromagnetic beam into a cellar at the Earth's surface surrounding a wellhead, and to generate the high energy electromagnetic beam to be incident on a rock in the cellar, wherein the high energy electromagnetic beam fritters the rock;
an emitter controller configured by software therein to control an operation and the direction of the high energy electromagnetic beam; and
a control loop configured to maintain alignment of the high energy electromagnetic beam with the cellar throughout the frittering to ensure beam/cellar coincidence.

2. The system of claim 1, wherein the high energy electromagnetic emitter is disposed above the Earth's surface.

3. The system of claim 1, wherein the high energy electromagnetic emitter is a laser.

4. The system of claim 1, wherein the high energy electromagnetic beam is a coherent laser beam.

5. The system of claim 1, further comprising:
an imaging sub-system configured to obtain an image of the rock in the cellar.

6. The system of claim 1, wherein the imaging sub-system includes:
a camera configured to obtain the image; and
a camera controller configured by software therein to control the camera.

7. The system of claim 6, wherein the imaging sub-system includes an output device configured to output the image.

8. The system of claim 7, wherein the output device is a monitor configured to display the image.

9. A system, comprising:
a high energy electromagnetic emitter configured to aim a high energy electromagnetic beam into a cellar at the Earth's surface surrounding a wellhead, and to generate the high energy electromagnetic beam to be incident on a rock in the cellar, wherein the high energy electromagnetic beam fritters the rock;
an emitter controller configured by software therein to control an operation and the direction of the high energy electromagnetic beam;
a control loop configured to maintain alignment of the high energy electromagnetic beam with the cellar throughout the frittering to ensure beam/cellar coincidence; and
an imaging sub-system including:
a camera configured to obtain an image of the rock in the cellar; and
an output device configured to output the image.

10. The system of claim 9, wherein the high energy electromagnetic emitter is disposed above the Earth's surface.

11. The system of claim 9, wherein the high energy electromagnetic emitter is a laser.

12. The system of claim 9, wherein the high energy electromagnetic beam is a coherent laser beam.

13. The system of claim 9, wherein the imaging sub-system includes:
a camera configured to obtain the image; and
a camera controller configured by software therein to control the camera.

14. The system of claim 9, wherein the imaging sub-system includes an output device configured to output the image.

15. The system of claim 14, wherein the output device is a monitor configured to display the image.

16. A method, comprising:
aiming a high energy electromagnetic beam emitter at a rock in a cellar at the Earth's surface surrounding a wellhead;
generating a high energy electromagnetic beam above the Earth's surface;
directing the high energy electromagnetic beam at the rock, thereby frittering the rock; and
maintaining alignment of the high energy electromagnetic beam with the cellar throughout the frittering using a control loop to ensure beam/cellar coincidence.

17. The method of claim 16, further comprising:
obtaining an image of the rock; and
displaying the image.

18. The method of claim 16, wherein the high energy electromagnetic beam is a coherent laser beam.

19. The method of claim 16, wherein the high energy electromagnetic beam is emitted by a high energy electromagnetic emitter disposed above the Earth's surface.

20. The method of claim 19, wherein the high energy electromagnetic emitter is a laser.
